(19) United States
(12) Patent Application Publication
(10) Pub. No.: US 2008/0139114 A1
(43) Pub. Date: Jun. 12, 2008

(54) METHOD FOR DETERMINING USER LOCATION BASED ON ASSOCIATION WITH SEAMLESS MOBILITY CONTEXT

(75) Inventor: Murali Ranganathan, Phoenix, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, AZ (US)

(21) Appl. No.: 11/567,289

(22) Filed: Dec. 6, 2006

(51) Int. Cl. H04B 5/02

(52) U.S. Cl. 455/41.1

(57) ABSTRACT

A method and apparatus that determines and reports a mobile device location based on the association of the mobile device with other nearby devices rather than based on an absolute geographic location of the mobile device. Contextual information is received by the mobile device from associated devices and transmitted via a mobile access network to a location server. Context information is forwarded from the location server to report mobile device location based on context with the associated devices.

### FIELD OF THE INVENTION

The present invention relates generally to mobile wireless communications devices, and in particular, a method and apparatus that employs geographical location determination systems.

### BACKGROUND

Enhanced 911 (hereinafter “E911”) is a part of the 911 system that automatically associates a geographical location with a caller's phone number. The Federal Communication Commission's E911 mandate requires that all mobile phones are able to be located with a reasonable accuracy and that the location be available to emergency call dispatchers. Global Positioning Systems (hereinafter “GPS”) functionality can be used by emergency services and location-based services to locate mobile phones and mobile devices.

Global Positioning Systems have been in use for quite some time. The system is made up of more than two dozen orbiting GPS satellites, twenty-nine active and three spare; though only twenty-four are needed for global coverage. More than fifty GPS satellites have been launched since 1978. Each satellite contains a computer, atomic clock and a radio. Using these and an understanding of its own orbit, each satellite continually broadcasts its changing position and time, while once a day confirming its own time and position against a fixed ground station; making any necessary minor corrections. These precise timing and position signals broadcast in radio frequency, allow a GPS receiver to accurately determine a location of the GPS receiver (longitude, latitude, and altitude) in any weather, day or night, anywhere on Earth. The GPS satellites are positioned in orbit such that from any given point on Earth, at least four GPS satellites are above the horizon. The GPS receiver contains a computer that calculates its own position using a process called trilateration, which is similar to triangulation. Trilateration is a method of determining the relative positions of objects using the geometry of triangles. Unlike triangulation, which uses angle measurements together with at least one known distance to calculate a subject's location, trilateration uses the known locations of two or more reference points, and a measured distance between the subject and each reference point. The GPS receiver calculates the time signals from at least three GPS satellites to measure its distance from each and to calculate its location. The calculation result is provided in the form of a geographic position—longitude and latitude. The location accuracy is anywhere from 1 to 100 meters depending on the type of equipment used. The GPS, officially called the Navigation Signal Timing and Ranging Global Positioning System (“NAVSTAR”), is owned and operated by the U.S. Department of Defense, but is available for general use around the world.

The current GPS location solution for mobile phones is very dependent on a mobile phone incorporating a GPS receiver, providing electrical energy to power the GPS receiver and to process the location calculations. To overcome some of the power and processing requirements, most current GPS receiver equipped mobile phones use Assisted GPS (hereinafter “AGPS”). AGPS works by having the GPS receiver of a mobile phone or mobile device take a snap shot of the satellite signals and then, using a cellular network, send the satellite signal data to an Assistance Server. The assistance server accesses information from a reference network. The assistance server has computing power that far exceeds computing power of mobile phones. The assistance server then communicates with the GPS receiver on the mobile phone or mobile device over the cellular network or the assistance server can relay the location of the mobile phone or mobile device directly to E911 authorities.

The current location solution for mobile phones that do not incorporate a GPS receiver is radiolocation. Radiolocation is the process of finding something through the use of radio waves. Most often this is done through trilateration using one of two methods: angle of arrival and time difference of arrival. Angle of arrival (hereinafter “AOA”) requires at least two communication towers. AOA locates a caller at the point where the lines along the angles from each tower intersect. Time difference of arrival (hereinafter “TDOA”) works using multilateration techniques. With TDOA, the network, not the mobile device, determines the time difference and therefore the distance that the mobile device is from each tower. Most Time Division Multiple Access (hereinafter “TDMA”) and Global System for Mobile communications (hereinafter “GSM”) networks use TDOA while Code Division Multiple Access (hereinafter “CDMA”) networks usually use hand-set based techniques, such as GPS.

As of September 2006, the mobile phone GPS system is not in place in most parts of the United States. And, AGPS methods provide a false sense of accuracy and are susceptible to limited cellular coverage. Both GPS and AGPS are susceptible to satellite signal attenuation when their signals are received indoors and in heavy urban areas. Furthermore, in order to enable a mobile phone or mobile device that is capable of receiving and processing a GPS or AGPS signal, a GPS chip or circuit must be added to the mobile phone or mobile device, which significantly increases the cost of the mobile phone or mobile device. While traditionally not requiring any modification to the mobile phone or mobile device, AOA and TDOA do require a line-of-sight to the network towers, which is difficult or impossible in heavy urban areas, and from within many man-made structures, e.g., around skyscrapers, around mountainous terrain, and within building complexes.

What is needed is a method and apparatus for determining a mobile device's location that is not dependent on long distance signal dependent trilateration techniques or that requires complex, high energy usage of GPS circuitry.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1a is an exemplary network system setup in accordance with some embodiments of the invention.

FIG. 1b is an exemplary block diagram of the Call Processing Overview in accordance with some embodiments of the invention.

FIG. 2 is an exemplary block diagram of the communication paths for information conveyed from a mobile device to the E911 system in accordance with some embodiments of the invention.

FIG. 3 is an exemplary flow chart diagram of the communication paths for information conveyed from a mobile device to the E911 system in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF VARIOUS EMBODIMENTS OF THE INVENTION

Before describing in detail embodiments that are in accordance with the present invention, it should be observed that the embodiments reside primarily in combinations of method steps and apparatus components related to determining a mobile device location from contextual information received from other nearby devices. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of determining a mobile device location from contextual information received from other nearby devices described herein. The non-processor circuits may include, but are not limited to, a radio receiver, a radio transmitter, signal drivers, clock circuits, power source circuits, and user input devices. As such, these functions may be interpreted as steps of a method to perform determining a mobile device location from contextual information received from other nearby devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method is disclosed for determining the location of a mobile device through the use of information received from other nearby devices, whose location is usually known. The method includes creating an association by seamless electronic communication with various devices using near-field communication techniques. The method further includes the transmitting of the mobile device location to a location server through the use of a cellular access network. The mobile device location is then stored and reported to an approved authority.

A system for determining a mobile device's location through the use of information received from other nearby devices and a mechanism to seamlessly establish contextual information from these nearby devices is disclosed. The system includes a mobile device capable of establishing electronic communications with multiple nearby devices and further capable of requesting and receiving contextual information from these nearby devices. The mobile device is then able to transmit this contextual information to a location server to be stored until requested by E911 authorities.

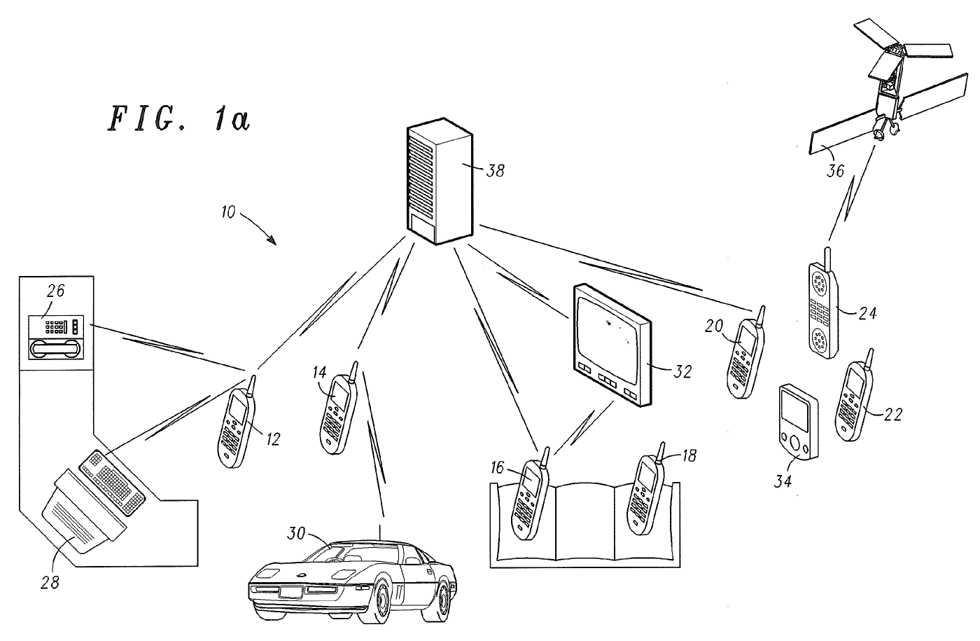

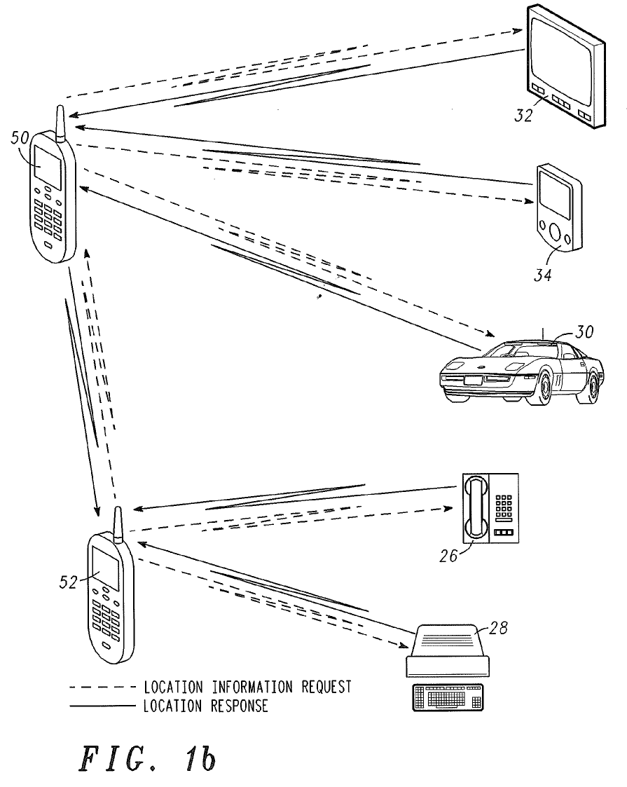

Referring now to FIG. 1a, an exemplary network system setup 10 in accordance with some embodiments of the invention is shown. A mobile device 12 is wirelessly connected to a Cellular Access Network (not shown). The mobile device 12 is shown to be a mobile phone as is known in the art. However, the mobile device 12 can be any type of mobile device capable of communicating through the Cellular Access Network, such as, but not limited to, a laptop or a personal data assistant. The mobile device 12 has a transceiver circuit required for communicating within a mobile cellular access network and a near-field communication circuit. The near-field communication circuit can be any type of short range wireless communication circuitry such as a Bluetooth circuit, a RFID Reader, or a UPnP™ circuit (Universal Plug and Play). Bluetooth technology replaced the cables that connect portable and fixed devices while maintaining high levels of security. Generally, a Bluetooth enabled device can communicate to other Bluetooth enabled devices in its proximity. These devices connect through a synchronized short range network known as a piconet. RFID readers are capable of communicating with RFID tags which are small objects that are attached or incorporated into a product, animal or person. RFID tags contain internal read/writeable memory and antennas that enable them to receive and respond to radio frequencies. The memory on the RFID tag can be accessed by a RFID reader through a RF interface. A UPnP™ circuit is essentially a wireless USB (Universal Serial Bus) connection enabling peer-to-peer connection of devices. UPnP™ architecture leverages TCP/IP and the Web to enable seamless proximity networking in addition to control and data transfer among networked devices in the home, office, and everywhere in between. UPnP™ call processing commands enable peer-to-peer communication between the mobile device 12 and a nearby device by 1) establishing what a device capability is; 2) processing a request from the mobile device 12 and responding to that request; 3) creating an association with the mobile device 12; and 4) sending the location information of that nearby device. Depending on the specific near-field technology used and the environmental conditions, such as walls, air pollution, or various other obstacles, wireless associations can be created between the mobile device 12 and nearby devices in the range of between 0-20 feet or 0-100 feet.

The mobile device 12 electrically connects and creates an association with a desk phone 26 and an office computer 28. The desk phone 26 and the office computer 28 may each contain a near-field communication device, such as a Bluetooth circuit, RFID Tag or RFID Reader, or a UPnP™ circuit in order to connect to the mobile device 12. The mobile device 12 may also be physically connected to the desk phone 26 or the office computer 28 through a USB or mini-usb connection. The desk phone 12 and the office computer 28 each contain within a memory or within the near-field communication circuit, identity information that can describe any of a multiple of items such as: where they are physically located; what they are; what function they perform; who they belong to; or any other type of general information. As an example, the identity information for the desk phone 26 can be a physical address of a building where the desk phone 26 is; while the identity information for the office computer 28 can contain the name of a company that owns the computer 28. The mobile device 12 receives the identity information from the desk phone 26 and the office computer 28 through the electrical connection. The mobile device 12 sends a combination of the identity information from the desk phone 26 and the office computer 28 to a location server 38 through the cellular access network. The location server 38 is a network server known within the art. The location server 38 is capable of receiving the identity information from the mobile device 12. The location server 38 contains a database to store the identity information received from the mobile device 12. Using the identity information received from the mobile device 12, the location server 38 creates a context information record describing the location of the mobile device 12. As an example, the context information can contain information stating that the mobile device 12 is by the desk phone 26 and the office computer 28 which are at a particular company and at a certain address. The location server 38 can then report the contextual information when requested.

A mobile device 14 can be the same type of mobile device as the mobile device 12 or it can be a different type of mobile device previously stated, e.g., a mobile phone, laptop or PDA. The mobile device 14 also contains a transceiver to communicate through the cellular access network as well as a near-field communication circuit. In this example, the mobile device 14 is in near proximity to an automobile 30. The automobile 30 may have a near-field communication circuit or may be adapted to physically connect to the mobile device 14 through a USB port, a mini-usb port or other physical connection. The automobile 30 contains within a memory circuit or within the near-field communication circuit, identity information. As an example, the identity information of the automobile 30 lists that it is an automobile owned by a certain individual. The automobile 30 may also have a GPS or other geographical tracking capabilities, such as LoJack (a radio based homing device). The mobile device 14 electrically connects to the automobile 30 and creates an association with the automobile 30. The mobile device 14 receives the identity information, which may include GPS coordinates or other geographical tracking information, from the automobile 30. The mobile device 14 then sends the identity information to the location server 38. The location server 38 stores the identity information and creates a context information record. The context information record describes that the mobile device 14 is in the automobile 30 owned by the certain individual which is at a particular location or can be found through rescue vehicles utilizing the other geographical tracking information.

A mobile device 16 can be the same type of mobile device as the mobile device 12 or mobile device 14 or it can be a different type of mobile device previously stated. As with the previous mobile device 12, 14, the mobile device 16 contains a transceiver to communicate through the cellular access network as well as a near-field communication circuit. In this example, the mobile device 16 is in near proximity to another mobile device 18 and a television 32. The mobile device 18 can be the same type of mobile device as the mobile device 16 or it can be any other type of mobile device. In this example, the mobile device 18 and the television 32 each have a near-field communication circuit. The mobile device 18 and the television 32 also contain within the memory of the near-field communication circuit, identity information describing their location, function, or other general information. In this example, the identity information of the mobile device 18 can be ownership information listing that the mobile device 18 is owned by a person named Cheryl. The television 32 identity information can list that it is a television at the home of Bob and Cheryl. The mobile device 16 is owned by Bob. The mobile device 16 electrically connects to the television 32 and receives the identity information from the television 32. The mobile device 16 sends the identity information to the location server 38. The location server 38 stores the identity information received from mobile device 16. The location server 38 creates a context information record. The context information record describes that the mobile device 16 is at Bob and Cheryl's home. The mobile device 16 can also either simultaneously or at a separate time connect with the mobile device 18. The mobile device 16 receives identity information from the mobile device 18. The mobile device 16 sends the identity information, now updated with identity information from the mobile device 18, to the location server 38. The location server 38 updates the context information record. The context information record now describes that Bob must be at home with Cheryl based on the association of the mobile device 16 with the television 32 and the mobile device 18.

In an additional example, a mobile device 20 is shown. The mobile device 20 can be the same type of mobile device as the mobile device 12, 14, 16, or it can be a different type of mobile device previously stated. In this example, the mobile device 20 is in near proximity to a mobile device 22, a PDA 34, and a mobile phone 24. The mobile device 22 can be the same as the mobile device 12, 14, 16, 18, 20, or another type of mobile device previously described. PDA 34 can be a mobile device like the mobile device 20 or it can be any other type of portable electrical device, such as an IPOD or a pager. The mobile phone 24 is a mobile phone equipped with a GPS receiver. Although the mobile phone 24 is shown as a mobile phone, the mobile phone 24 can be a PDA with a GPS receiver, a laptop with a GPS receiver, or any derivation thereof with a GPS receiver. The mobile phone 24 is in radio communication with a series of GPS satellites 36. The mobile phone 24 receives timing and position signals from the GPS satellites 36 to calculate its geographic position. The mobile device 22, the PDA 34 and the mobile phone 24 each have a near-field communication circuit and store identity information. The identity information for the mobile phone 24 can contain GPS coordinates in the form of latitude and longitude or a physical address. The mobile device 20 electrically connects to the mobile device 22, the PDA 34 and the mobile phone 24. It should be noted that the mobile device 20 can connect to the mobile device 22, the PDA 34 and the mobile phone 24 at or near the same time or the mobile device 20 can connect to the mobile device 22, the PDA 34 and the mobile device 24 at different times. The mobile device 20 receives identity information from the mobile device 22, the PDA 34 and the mobile phone 24. The mobile device 20 sends the combined identity information to the location server 38. The location server 38 stores the combined identity information received from the mobile device 20. The location server 38 creates a context information record describing that the mobile device 20 is near the mobile device 22, the PDA 34, and the mobile phone 24 which are all at a specific geographic location defined by the GPS coordinates in the identity information received from mobile phone 24 through mobile device 20. Therefore, the context information record created by the location server 38 would indicate that a user owning the mobile device 20 is very likely geographically near a user owning the mobile device 22, a user owning the PDA 34, and a user owning the mobile phone 24 at the geographic position based on the GPS signals received by the mobile phone 24.

Referring now to FIG. 1b, an exemplary block diagram of a Call Processing Overview in accordance with some embodiments of the invention is shown. Illustrated is an example of the call processing that takes place from a first mobile device 50 and a second mobile device 52. The first mobile device 50 and the second mobile device 52 can be any types of mobile device previously described in accordance with some embodiments of the invention. The first mobile device 50 and second mobile device 52 each contain a transceiver for communication with the cellular or mobile access network and a near-field communication circuit, as previously described. The first mobile device 50 attempts to create a communication link and association with nearby devices, such as the television 32, the PDA 34, and the automobile 30 using the near-field communication circuit, such as Bluetooth, RFID, or UPnP™. The second mobile device 52 attempts to create a communication link and association with other nearby devices, such as the desk phone 26 and the office computer 28.

The first mobile device 50 attempts to setup an association with the television 32, the PDA 34, and the automobile 30. Once a communication link is established and an association is created, the first mobile device 50 sends a location request independently to the television 32, the PDA 34, and the automobile 30. Therefore, three separate location requests are sent; one location request to the television 32, one location request to the PDA 34, and one location request to the automobile 30. Each particular device, the television 32, the PDA 34, and the automobile 30, when receiving a location request will, in response, send a location response back to the first mobile device 50. The location response sent by each of the particular devices, the television 32, the PDA 34, and the automobile 30, will contain location information about the location of that particular device. This location information can be based on a GPS signal, preprogrammed location information, or it can be other identification information of that particular device. The first mobile device 50 stores the information received from each particular device.

The second mobile device 52 shows another example of the association and reception of location information records from contextual devices, the desk phone 26 and the office computer 28. The second mobile device 52, like first mobile device 50, sends out a location request to each device, the desk phone 26 and the office computer 28. In response to the location request, each device, the desk phone 26 and the office computer 28, provide location response information. The location response information can state that it is a phone, from the desk phone 26, or a computer, from the office computer 28. The location response information can provide, if available, location information or, if not available, provides identification information.

The first mobile device 50 and the second mobile device 52 can also communicate with each other and create an association there between. The first mobile device 50 and the second mobile device 52 can report to each other and provide their respective identification information. The location information received by each, the first mobile device 50 and the second mobile device 52, will be transmitted to the location server 38. Merging of the location information from the first mobile device 50 and the second mobile device 52 can be performed by the location server 38.

In each of the examples illustrated above with first mobile device 50 (including the examples provided with the mobile device 12, the mobile device 14, the mobile device 16, the mobile device 20, and the second mobile device 52 though not hereinafter specifically enumerated), a contextual association between the first mobile device 50 and nearby devices, for example, the television 32, the PDA 34, and the automobile 30, can be updated at a pre-determined time interval or upon the non-receipt of a signal from the nearby device, the television 32, the PDA 34, and the automobile 30. If the first mobile device 50 is physically connected to the nearby device, the television 32, the PDA 34, and the automobile 30, termination of the physical connection can result in non-receipt of the signal. If the first mobile device 50 is wirelessly connected to the nearby device, the television 32, the PDA 34, and the automobile 30, then a separation distance between the first mobile device 50 and the nearby devices in excess of the near-field communication distance can result in non-receipt of the signal. When non-receipt of the signal of an associated device occurs, the first mobile device 50 removes the location identification information from the device whose signal was lost from its memory. The first mobile device 50 then sends an update record message to the location server 38 to remove the same from the context information record. Furthermore, the first mobile device 50 can mark the location identification information received from a nearby device with the time that the first mobile device 50 received the location identification information. The location server 38 can also mark the location identification information received from the first mobile device 50 with the time that the location identification information was received by the first mobile device 50. The location server 38 can also mark the location identification information with the time that the location identification information was received by the location server 38. Therefore, the contextual association of the first mobile device 50 with nearby devices can either be updated at a specific time interval, asynchronously or both.

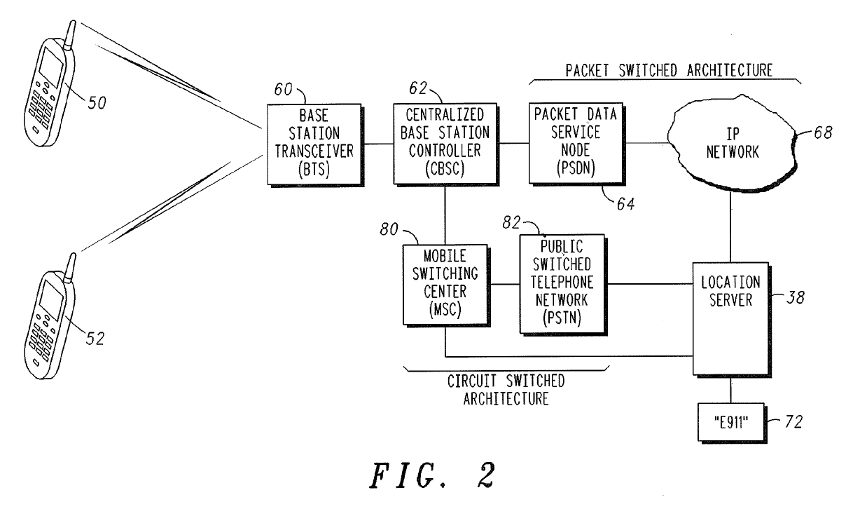

Referring now to FIG. 2, an exemplary block diagram of the communication paths for information conveyed from the first mobile device 50 and second mobile device 52 to an E911 system 72 in accordance with some embodiments of the invention is shown. After the first mobile device 50 and the second mobile device 52 have obtained and stored the location information from nearby devices, the first mobile device 50 and the second mobile device 52 must each transmit the location information to the location server 38. The transmission is typically done via a wide area wireless network (Cellular Access Network). The first mobile device 50 and the second mobile device 52 are wirelessly connected to the cellular access network through methods known in the art. The first mobile device 50 and the second mobile device 52 initially communicate with a Base Station Transceiver (hereinafter “BTS”) 60. The BTS 60 communicates with a Centralized Base Station Controller (hereinafter “CBSC”) 62. The CBSC 62 communicates with a Packet Switched Architecture, e.g., IP based connection. In a Packet Switched Architecture, the CBSC 62 communicates with a Packet Data Service Note (hereinafter “PDSN”) 64. The PDSN 64 forwards an IP packet to an IP Network 68. The IP Network 68 routes the IP packet to the location server 38. The location server 38 contains a database that stores the location identification information sent by the first mobile device 50 and the location identification information sent by the second mobile device 52. The database within the location server 38 creates a context information record for the first mobile device 50 and a context information record for the second mobile device 52. The location server 38 maintains the location identification information from the first mobile device 50 and the second mobile device 52. The database within the location server 38 can also build on the stored location identification information with an updated location identification information received from the first mobile device 50 and the second mobile device 52. As an example, if the first mobile device 50 previously transmitted location identification information received from the television 32, and the association between the first mobile device 50 and the television 32 is still active, the location server 38 can add information received from the first mobile device 50 that the first mobile device 50 later received from association with the automobile 30. The E911 system 72 can then query the database within the location server 38 when location information about the first mobile device 50 is required.

In another embodiment, a Circuit Switched Architecture can be used to transmit the information from the first mobile device 50 and second mobile device 52 to the location server 38. In this example, the CBSC 62 connects and communicates with a Mobile Switching Center (hereinafter “MSC”) 80. The MSC 80 can connect to a Public Switched Telephone Network (hereinafter “PDSN”) 82 to send information to the location server 38, or the MSC 80 can connect directly to the location server 38.

The location server 38 can also associate records received from the first mobile device 50 and the second mobile device 52. If the first mobile device 50 reports a contextual association with a device that is identical to a device that is reported by the second mobile device 52, the location server 38 can determine that the first mobile device 50 and the second mobile device 52 are in near proximity to each other despite the fact that neither mobile device reported the contextual association with the other.

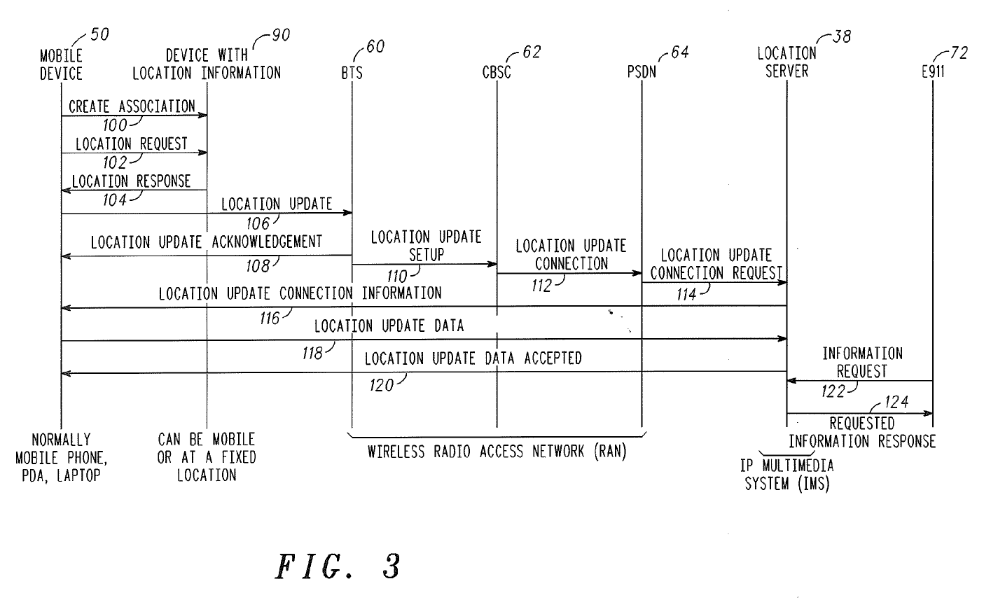

Referring now to FIG. 3 an exemplary flow chart diagram of the communication paths and messaging for information conveyed from a mobile device 50 to the location server 38 and the E911 system 72 in accordance with some embodiments of the invention is shown. The mobile device 50 sends a message to create an association 100 with a device 90 through a physical connection or through at least one of the previously mentioned near-field communication technologies. The device 90 can be any device, mobile or fixed, that is capable of associating with the mobile device 50, contains location information or identification information, and a means to communicate the location information to the mobile device 50, such as through a USB connection, a mini-usb connection, a Bluetooth connection, a RFID Tag or RFID Reader connection, or a UPnP™ connection. When the association between the mobile device 50 and the device 90 is created, the mobile device 50 sends a location request 102 to the device 90. The device 90 responds back with a location response 104 containing a location identification information data such as a geographical address, a device identification or name, a GPS information, or any information describing the device 90 or its location. When the mobile device 50 receives the location response 104, the mobile device 50 stores the location identification information data contained within the location response 104. The mobile device 50 sends a location update request message 106 to a wireless access network, which could be any wireless communication network as is known in the art, to the BTS 60. The BTS 60 sends a location update acknowledge message 108 to confirm that the location update request message 106 has been received. Since a wireless access network is not a guaranteed link, and thus, if the location update acknowledge message 108 is not received in a specified time, the mobile device 50 resends the location update message 106 repeatedly until the location update acknowledge message 108 is received. The BTS 60 sends a location update setup message 110 to the CBSC 62. The CBSC 62 identifies that this is a location update message and sends a location update connection message 112 to the PDSN 64. The PDSN 64 determines which location server 38 should receive the location update connection request 114. The PDSN 64 sends a location update connection request 114 to the specific location server 38 that it determined is supposed to receive the location update connection request 114. Although a Packet Switched Architecture is illustrated, those skilled in the art can appreciate that a similar messaging structure may be used for the previously illustrated Circuit Switched Architecture. The location server 38 receives the location update connection request 114. The location update connection request 114 contains information necessary for the location server 38 to know which specific mobile device 50 is requesting the location update. The location update connection request 114 also contains necessary information for the location server 38 to be able to connect directly to the mobile device 50. The location server 38 sends a location update connection information message 116 directly to the mobile device 50. The location update connection information message 116 tells the mobile device 50 the type of server that the location server 38 is and the type of information that the location server 38 can handle. The mobile device 50 formats the location identification information data that the mobile device 50 previously received and stored from the device 90 so that it can be read and stored by the location server 38. The mobile device 50 then responds directly to the location server 38 with a location update data message 118. The location update data message 118 contains the location identification information data that the mobile device 50 previously received and stored from the device 90.

The location server 38 can generate an algorithm to act on the location identification data, create a context information record, or build upon previously stored location information data. The location identification information may include one or more of the following types of information: latitude, longitude information; GPS location identification information; near related device information; a listing of devices identified as being in a near-field, etc.

The E911 system 72 can query the location server 38. As an example, if the mobile device 50 called 911 with an emergency, an E911 operator 72 can send a request 122 to the location server 38 requesting the context information record of the mobile device 50. The location server 38 responds 124 with the context information record containing all the most recent or most pertinent location identification information data the location server 38 has received from the mobile device 50.

Therefore, even though the mobile device 50 does not contain a GPS receiver, the E911 system 72 can determine information about the status of the operator of the mobile device 50 and geographically related location information based on the contextual location identification information received by the mobile device 50. The mobile device 50 could be at work, near a mobile device that has GPS, could be near a facility that has a known geographical location, or near a person or object with an RFID tag that lists that person or object as having a particular geographical location.

Therefore, a device with more accurate location determination capabilities, such as GPS, can provide location information to the mobile device 50 with less accurate location determination capabilities. The mobile device 50 uses the information from contexts surrounding the user to provide assistance to the user requiring help from law enforcement (911). Furthermore, combining information from different contexts provides an enhanced knowledge that could not readily be obtained otherwise.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A mobile device comprising:
a memory comprising a memory space for storing a location identification information of at least one of a plurality of nearby electronic devices;
a wireless transceiver circuit for communicating with a mobile communication network;
a near field communication circuit for receiving a location identification information from said at least one of a plurality of nearby electronic devices; wherein said near field communication circuit transmits information requests to said at least one of a plurality of nearby electronic devices; wherein said near field communication circuit receives said location identification information from said at least one of a plurality of nearby electronic devices that is within a near field communication range;
a microprocessor based circuit in electronic communication with said near field communication circuit, said memory and said wireless transceiver; wherein said microprocessor stores said location identification information in said memory space;
wherein said wireless transceiver transmits said location identification information to a location server in said mobile communication network.

2. A device of claim 1, wherein said near field communications circuit is at least one of a RFID reader, a Bluetooth Circuit, and a UPnP communication circuit.

3. A device of claim 1, wherein said location identification information comprises at least one of a latitude and longitude, a GPS location identification, a physical address, an ownership name, and an identification information about said at least one of said plurality of electronic devices.

4. A device of claim 1, wherein said mobile communication device is at least one of a mobile phone, a laptop computer, and a personal data assistant.

5. A device of claim 1, wherein said near field communication range is within a distance of 20 feet from said mobile device.

6. A device of claim 1, wherein said near field communication range is within a distance of 100 feet from said mobile device.

7. A mobile device comprising:
a wireless communications transceiver;
a memory for storing a location identification information of at least one device located in a near field communication range with respect to said mobile device;
a wireless short range transceiver for sending a request for and for receiving said location identification information from said at least one device;
a processor based circuit for storing said location identification information in said memory, and for providing said location identification information to said wireless communication transceiver for transmission to an approved authority;

8. A device of claim 7, wherein said approved authority is E911.

9. A device of claim 7, wherein said short range transceiver is at least one of a RFID reader, a Bluetooth Circuit, and a UPnP communication circuit.

10. A device of claim 7, wherein said location identification information comprises at least one of location and identification information about said at least one device.

11. A device of claim 10, wherein said location information comprises at least one of a latitude and a longitude, a GPS location identification, and a physical address.

12. A device of claim 7, wherein said at least one device is located within a near field range about said mobile device.

13. A method of determining a mobile device geographical location based on location and identification information from at least one device located in a near field range of said mobile device; the method comprising:
establishing communication between said mobile device and said at least one device located in the near field range of said mobile device through at least one of a USB connection, a Bluetooth communication, an RFID communication, and a UPnP communication;
requesting, by said mobile device, location identification information from said at least one device;
receiving location identification information from said at least one device through said established communication;
storing, in a memory of said mobile device, said location identification information received from said at least one device;
transmitting, from said mobile device, to a location server through a wireless access network said location identification information;
receiving said location identification information by said location server, creating a context information record of said mobile device using said location identification information;
updating said context information record of said mobile device upon receipt of additional location identification information from said mobile device;
transmitting said context information record to an approved authority upon request by said approved authority.

14. A method of claim 13, wherein said location identification information is stored for a specified duration of time.

15. A method of claim 13, wherein said context information record of a specific on of said at least one device is stored as long as said mobile device continues to receive location identification information from said specific device.

16. A method of claim 13, wherein said location identification information is at least one of a description of said at least one device, an address of said at least one device, a GPS location of said at least one device, a function of said at least one device, and an identification information of said at least one device.

17. A method of claim 13, wherein said location identification information of said at least one device is stored in said memory of said mobile device while said at least one device is within a near field range of said mobile device.

18. A method of claim 13, wherein said location identification information is marked with the time of receipt.

19. A method of claim 13, wherein said mobile device transmits to said location server, through said wireless access network, a removal request of said location identification information of said at least one device upon non-receipt of a previously received location identification information.

20. A method of claim 19, wherein said location server updates said context information record of said mobile device upon receipt of said removal request of said location identification information.
